(19) United States
(12) Patent Application Publication
(10) Pub. No.: US 2020/0242535 A1
(43) Pub. Date: Jul. 30, 2020

(54) System and Method for Optimally Presenting Workplace Interactions

(71) Applicant: Qoreboard, Inc., Katy, TX (US)

(72) Inventor: Michael Dennis Midgett, JR., Katy, TX (US)

(21) Appl. No.: 16/775,381

(22) Filed: Jan. 29, 2020

Related U.S. Application Data
(60) Provisional application No. 62/798,190, filed on Jan. 29, 2019.

(51) Int. Cl. G06Q 10/06; G06N 20/00

(52) U.S. Cl. CPC G06Q 10/06398; G06Q 10/06395; G06N 20/00; G06Q 10/06393

(57) ABSTRACT

The present invention is a system and method for providing a best way to present interventions to an employee. In an embodiment, company macro goals are broken down and assigned to employee groups; the assigned goals are further assigned to individuals within each group. The individual's assigned goal quota is broken down into the goal quota's smallest feasible trackable and measurable increments. Employee performance data is dynamically tracked and machine learning compares the performance to a baseline. The system dynamically provides granular feedback to an individual employee based upon the analysis performed though machine learning. Such granular feedback is delivered to the employee as a visualization on a device. Employees may be incentivized to use the system by personalization of the feedback and gamification.

### CLAIM TO PRIORITY

This Non-Provisional application claims under 35 U.S.C. § 120, the benefit of the Provisional Application 62/798,190, filed Jan. 29, 2019, Titled “System and Method for Presenting Performance Management Interventions,” which is hereby incorporated by reference in its entirety.

### COPYRIGHT NOTICE

A portion of the disclosure of this patent document contains material which is subject to copyright protection. The copyright owner has no objection to the facsimile reproduction of the patent document or the patent disclosure, as it appears in the Patent and Trademark Office patent file or records, but otherwise reserves all copyright rights whatsoever.

### BACKGROUND

Any workplace environment overseen by a management hierarchy requires constant communication between workers and one or more managers, the rational goal of such communication being maximal workplace efficiency. Managerial interventions intended to affect such communication include but are not necessarily limited to written messages, motivational actions, training actions and corrective actions. While managerial interventions personalized to individual employees may produce better results, such interventions are commonly presented in a one-size-fits-all approach.

Such “cookie-cutter” approaches to the provision of managerial interventions are often the result of two factors preventing the realization of more penetrating managerial insights. The first factor, time constraint, prevents a manager from devoting sufficient time to the customization and personalization of interventions necessary to maximize their effectiveness. The second factor, failure to understand idiosyncrasies of an individual's workplace habits, prevents a manager from regularly delivering an intervention at the moment when the intervention will have its greatest effect.

### BRIEF DESCRIPTION OF THE DRAWINGS

Certain illustrative embodiments illustrating organization and method of operation, together with objects and advantages may be best understood by reference to the detailed description that follows taken in conjunction with the accompanying drawings in which:

FIG. 1 is a process flow view of goal assignment consistent with certain embodiments of the present invention.

FIG. 2 is a process view of messaging determination consistent with certain embodiments of the present invention.

FIG. 3 is a process view of user intervention, gamification, and messaging determination consistent with certain embodiments of the present invention.

FIG. 4 is a view of a user experience of data visualization consistent with certain embodiments of the present invention.

### DETAILED DESCRIPTION

While this invention is susceptible of embodiment in many different forms, there is shown in the drawings and will herein be described in detail specific embodiments, with the understanding that the present disclosure of such embodiments is to be considered as an example of the principles and not intended to limit the invention to the specific embodiments shown and described. In the description below, like reference numerals are used to describe the same, similar or corresponding parts in the several views of the drawings.

The terms “a” or “an”, as used herein, are defined as one or more than one. The term “plurality”, as used herein, is defined as two or more than two. The term “another”, as used herein, is defined as at least a second or more. The terms “including” and/or “having”, as used herein, are defined as comprising (i.e., open language).

Reference throughout this document to “one embodiment”, “certain embodiments”, “an embodiment” or similar terms means that a particular feature, structure, or characteristic described in connection with the embodiment is included in at least one embodiment of the present invention. Thus, the appearances of such phrases or in various places throughout this specification are not necessarily all referring to the same embodiment. Furthermore, the particular features, structures, or characteristics may be combined in any suitable manner in one or more embodiments without limitation.

Reference throughout this document to “device” refers to any electronic communication device with network access such as, but not limited to, a cell phone, smart phone, tablet, iPad, networked computer, internet computer, laptop, watch or any other device, including Internet of Things devices, a user may use to interact with one or more networks.

However, unless specifically stated otherwise as apparent from the following discussion, it is appreciated that throughout the description, discussions utilizing terms such as “processing” or “computing” or “calculating” or “determining” or “displaying” or the like, refer to the action and processes of a computer system, or similar electronic computing device (such as a specific computing machine), that manipulates and transforms data represented as physical (electronic) quantities within the computer system memories or registers or other such information storage, transmission or display devices.

Reference herein to “DMI.AI™” refers to just-in-time data visualizations, messages, interventions, alerts and insights.

Reference herein to “Microgoals™” refers to the smallest feasible trackable and measurable increments of an individual's contribution toward a company's macro goal.

Reference herein to “QOREBOARD® process” refers to a process of aligning individual Microgoals™ with company goals and providing visual feedback regarding the sufficiency of such alignment to interested stakeholders.

Reference herein to “Microadjustments™” refers to optimal behavioral interventions to maximize performance.

Reference herein to “parsing” refers to the process of examining an input dataset in a minute way and, as a result of such examination, determining rationally related subsets of the input dataset.

Reference herein to “atomizing” refers to individual treatment of rationally related subsets of input data.

Certain aspects of the embodiments include process steps and instructions described herein. It should be noted that the process steps and instructions of the embodiments can be embodied in software, firmware or hardware, and when embodied in software, could be downloaded to reside on and be operated from different platforms used by a variety of operating systems. The embodiments can also be in a computer program product which can be executed on a computing system.

The embodiments also relate to an apparatus for performing the operations herein, This apparatus may be specially constructed for the purposes, e.g., a specific computer, or it may comprise a computer selectively activated or reconfigured by a computer program stored in the computer. Such a computer program may be stored in a computer readable storage medium, such as, but is not limited to, any type of disk including floppy disks, optical disks, CD-ROMs, magnetic-optical disks, read-only memories (ROMs), random access memories (RAMs), EPROMs, EEPROMs, magnetic or optical cards, application specific integrated circuits (ASICs), or any type of media suitable for storing electronic instructions, and each coupled to a computer system bus. Memory can include any of the above and/or other devices that can store information/data/programs and can be transient or non-transient medium, where a non-transient or non-transitory medium can include memory/storage that stores information for more than a minimal duration. Furthermore, the computers referred to in the specification may include a single processor or may be architectures employing multiple processor designs for increased computing capability.

The processes and displays presented herein are not inherently related to any particular computer or other apparatus. Various systems may also be used with programs in accordance with the teachings herein, or it may prove convenient to construct more specialized apparatus to perform the method steps. The structure for a variety of these systems will appear from the description herein. In addition, the embodiments are not described with reference to any particular programming language. It will be appreciated that a variety of programming languages may be used to implement the teachings of the embodiments as described herein, and any references herein to specific languages are provided for disclosure of enablement and best mode.

Because “cookie-cutter” approaches to the provision of managerial interventions are often the result of time constraint, preventing a manager from devoting sufficient time to the customization and personalization of interventions necessary to maximize their effectiveness, or failure to understand idiosyncrasies of an individual's workplace habits, preventing a manager from regularly delivering an intervention at the most timely moment, there is a need for a manager to determine both a best way to present an intervention and a best time for presenting such interventions.

The present embodiments relate to a system and method to provide a best way to present interventions to an employee. Furthermore, the embodiments described herein relate to a method to deliver just-in-time data visualizations, messages, interventions, alerts and insights (DMI.AI™) to assist leaders in improving employee performance, executing employee performance management and motivating employees. In an embodiment, the instant innovation is a process to change the way strategic and financial goals are disseminated and aligned at every level of management hierarchy. In this system, the performance management plans are developed for an audience of one; the individual who must perform.

In an embodiment, the present innovation includes obtaining information regarding strategic and financial goals, both quantitative and qualitative, set by an organization's Executive Leadership and Board-Level leadership. Such goals may be tracked internally or reported externally to the public, to customers, or to shareholders. Company macro goals are broken down to show every functional grouping of employees. Each grouping may be differentiated by any number of criteria including, by way of non-limiting example, geographic location or workplace role. Macro goals are similarly broken down to identify the necessary goal-centric contribution required from each individual employee for the company to achieve the stated macro goal.

In an embodiment, the instant innovation further dissects each individual's macro goal contribution into the smallest trackable and measurable increments feasible. Herein, such trackable and measurable increments are called Microgoals™. By way of non-limiting example, a Microgoal™ may take the form of a Sales Agent's hourly, quarter-hourly, or minute-by-minute sales target. Alternatively, a Microgoal™ may be represented by the expected number of social media posts completed by Marketing Managers or the required number of a Chief Executive's daily face-to-face interactions with employees.

In an embodiment, the instant innovation tracks, monitors, displays and refreshes an individual employee's Microgoals™ through analysis of data that may be collected automatically or manually. The extent of the use of Microgoals™ may be dependent on the speed that the collected data is available. Ideally, such data availability is real-time from the perspective of the employee. The volume of data necessarily collected and processed to produce real-time insights necessitates collection and analysis by a server with a processor in communication with real-time data sources. Such data may be accessed through many sources including but not limited to internal and external databases, surveys, human interactions and leadership experience. The data is then joined in order to build a richly contextualized amalgamation of data. Analysis of this amalgamation using machine learning serves to dynamically guide the next best action for the individual by provision of granular feedback.

Data collection may be performed by clients using a combination of tools to track customer interactions both automatically without agent input and with agent input, but very granular and specific (name, address, credit card, items purchased and many more personally identifiable pieces of information). In a non-limiting example, a client may utilize Telephony systems to track the number of phone calls, who called, how long agents were on the phone, etc., utilize CRM systems track what is said, what actions were taken, next steps, etc., utilize billing systems to keep track of payments made, amounts due, etc., and/or utilize Salesforce software to track sales funnels, conversations, emails, to do's, etc. These tools generally take 1-3 days to process, synchronize, compile and join with the company's database (all of this is automated). Most clients don't see performance results until all processing is completed. Clients are typically unaware of what they sold or how many people called until 1-3 days after it happens.

In an embodiment, although these tools organize and track massive amounts of data that are helpful to senior leaders, operations leaders, finance, marketing and HR teams there is generally too much information to drive frontline performance. For frontline, customer-facing employees all that is needed to know is that a phone call happened and the employee either sold something or they did not. The system only needs to know that a customer walked into a retail location and the salesperson sold something or they did not sell something. The same thing applies to Customer Care centers. The system simply needs to know that a call happened and the someone returned their product, or they did not. The instant innovation's manual entry function tracks these very simple activities without all the meta data and focuses on tracking outcomes. By tracking these simple outcomes, the system may be able to show employee real time performance on those KPIs that matter most. This simplified approach has been proven to increase performance by 50-200%.

To perform the manual data collection, the system places a tile on our that allows the user to check a box every time they take a call or every time, they make a sale. Each time the user submits an activity the leaderboards update and the graphs update. The system may customize the tile and checkboxes to track any very simple measure that will drive performance.

In an embodiment, the present innovation aggregates all individual Microgoals™ into appropriate team, location, geographic, business unit and companywide Microgoals™ to render visualizations dashboards of all Microgoals™ and Microgoals™ anatomization. Management celebrates the achievement of each individual reaching their initial Microgoal and then they are urged/inspired to keep going by setting additional goals to be reached. Management sets a stretch goal determined by the client (+10%, +30%, etc.) and the system begins sending notifications and celebrations on making progress towards the new stretch goal. If the individual achieves the new stretch goal the system repeats the process at a higher goal. Microgoal™ visualizations deliver insights to company leaders at every level of management from frontline to CEO. These insights permit leaders to make decisions aligned toward a company's macro goals and to make optimal decisions that maximize profit.

The instant innovation's dissemination of information helps a company to maintain alignment across all members of the organization. Using a typical company model, goals are distributed top-down through a hierarchical dissemination plan that generally results in goals being set in department-specific silos, without concern of impact to other groups. This silo-effect drives internal conflict and company goal misalignment as teams are incentivized to make or exceed their targets regardless of the effect of attaining such target on the overall company goals.

In an embodiment, the present innovation employs a QOREBOARD® process to dynamically set goals based on a holistic strategy across business units, geographies and teams down to the individual. Such a process accounts for the positive or negative correlation of two or more goals set across groups. If for instance, the best outcome for the company is to raise one group's goal while lowering the goal of another group, the QOREBOARD® process can identify the conflict and inform leadership to make an intervention in real time. Through such intervention, leadership can prevent two opposing teams from destroying value to the company due to their desire to achieve their individual goal.

The instant innovation obtains user-specific preferences for coaching and motivation through onboarding, 3rd party testing, surveys, focus groups or individual discussions and compares employee performance using a processor to a historical baseline or to a Microgoal™. This comparison provides an analysis to determine the right DMI.AI™ to use at the optimal time. The instant innovation sends an automated DMI.AI™ to the device used by an individual, supervisor, team or group, prompting the recipients to take a specific action or make a behavioral Microadjustment™ in order to take advantage of an opportunity, to reach a goal or to maximize performance.

In an embodiment, the instant innovation may deliver pop-in notifications/alerts on a device screen with sound effects and personalization. Personalization can include, but may be not limited to avatars, logos, photos, headshots or emoticons.

In an embodiment, the invention uses machine learning to detect subtle patterns as a result of the deployed DMI.AI™, whether such patterns are human or digital, and tracks the impact of the deployed DMI.AI™ to measure performance improvement, decline, or static state over time. The instant innovation creates an individualized and customized performance management plan centered around each individual employee. The system, via a user device, sends the optimal intervention at the ideal time to maximize the individual's, team's or company's potential. In order to timely send optimal intervention, the instant innovation uses machine learning to analyze vast amounts of data at speeds not possible by the human mind. By evaluating large amounts of data within a compressed timeframe, the system makes possible the dynamic provision of timely, granular feedback.

The system sets a baseline for each employee performance once an intervention has been executed and then measures employee benefit or employee detriment post-intervention. Machine learning is employed to determine optimal interventions with the highest return on investment. The system repeats the cycle until the interventions are optimized for an individual.

In an embodiment the system measures millions of interventions over time to continue refining the optimal behavioral interventions and behavioral Microadjustments™ to maximize performance. In an embodiment, the instant innovation employs implementing gamification principles to motivate users. By way of non-limiting examples, such principles may allow individuals to choose their own reward for participation and then track employee progress towards that reward.

In an embodiment, the instant innovation analyzes incoming data to discern the exact timing to execute an DMI.AI™. By way of non-limiting example, in the case of a call center agent whose six-week average performance at 9 am is only one percent of the agent's daily sales volume, the QOREBOARD® alerts a supervisor to use the 9 am hour for coaching or training. In another non-limiting example, where a door-to-door salesperson has a Microgoal™ to knock 20 doors per hour, at 8:45 am QOREBOARD® sends the salesperson a notification that he/she has 15 mins to knock enough doors to meet quota.

In an embodiment, the instant innovation delivers individualized and relevant training content and coaching based on machine learning from previous coaching and training. Such content and coaching may be delivered in the form of small, result-oriented training modules referred to herein as Microcontent™, sent to a user device. Timely delivery of Microcontent™ reduces cost of training and minimizes lost productivity. Automated delivery of Microcontent™, along with other timely and customized performance management, reduces the need for high-touch supervisory interaction, in turn reducing operating costs. Delivering automated training DMI.AI™ that are timely and customized to the individual also reduces operating costs by eliminating unneeded training that may be ineffective for a given individual. Delivering Microcontent™ at the right time to minimize downtime costs and maximize retention reduces overall training costs and increases company return on investment.

In an embodiment the instant innovation allows employees to interact with their device-displayed dashboards using technologies including but not limited to talking dashboards and human voice recognition. In a non-limiting example, integrations with Artificial Intelligence assistants (by way of non-limiting example, Siri, Alexa, and Google) would be used to deliver DMI.AI™.

In an embodiment, the instant innovation allows companies to source new talent by delivering insights about employee personality traits and preferences. In addition, company job requisitions may be automatically generated to identify the optimal bounds and responsibilities for any particular role.

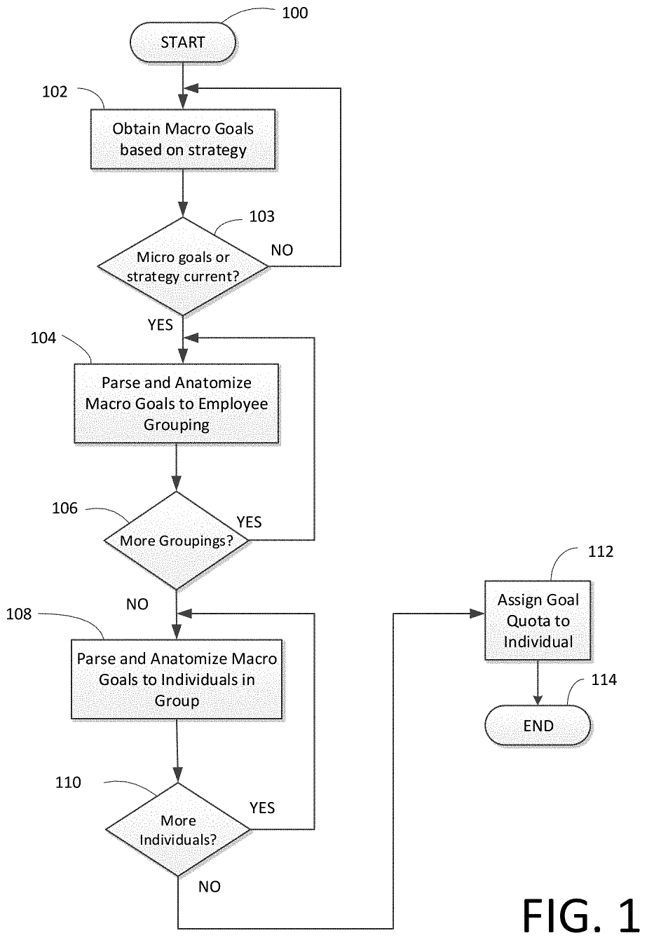

Turning now to FIG. 1, a process flow view of goal assignment consistent with certain embodiments of the present invention is shown. At 100, the process starts. At 102, the system obtains quantitative and qualitative strategic and financial goals (referred to herein as “macro goals”) set by the company Executive leadership and Board leadership and based upon the strategic goals previously set. In non-limiting examples, such goals could include sales targets, employee retention targets, growth objectives, long-term corporate expectations, revenue, profit, margins, and the like. These goals may be privately held or publicly reported, or may be a combination of private and public information. At 103 the system checks to determine if the micro goals or the strategy expressed for the employee and or employee group are in compliance with the current strategic goals for the company. If the micro goals or strategy are not in compliance, the system obtains the most current micro goals or strategic considerations and re-enters the check at step 102. Upon the determination that the micro goals are consistent with the most current goals and strategy, the system proceeds to step 104.

At 104 the macro goals are parsed and anatomized to determine to which employee grouping each goal segment should be assigned. By way of non-limiting example, macro goals with a sales component would be assigned to the sales team as opposed to a team more tangentially related to sales. At 106 the system determines whether there remain tasks as yet unassigned to a functional employee grouping. If so, then the system continues to break down the macro goals and assign to employee grouping at 104. If not, at 108 the system breaks down the macro goals that have been assigned to the employee groups to determine the portion of those macro goals optimally performed by an individual member of the employee group. By way of non-limiting example, tasks may be best assigned to the leader of an employee group, or one of a subset of an employee group, such as an industrial engineer in a group composed of mechanical, electrical, and industrial engineers. If at 110 the system determines that there remain yet more individuals to whom goal allocations can optimally be made, the system returns to parse and anatomize macro goals at 108. If at 100 the system has finalized parsing and anatomizing of macro goals, at 112 the system assigns a goal quota to an individual member of the employee group. Such goal quota represents the anatomized portion of the macro goals for which the individual takes responsibility in order to allow the company to optimally achieve the macro goals. At 114 the process ends.

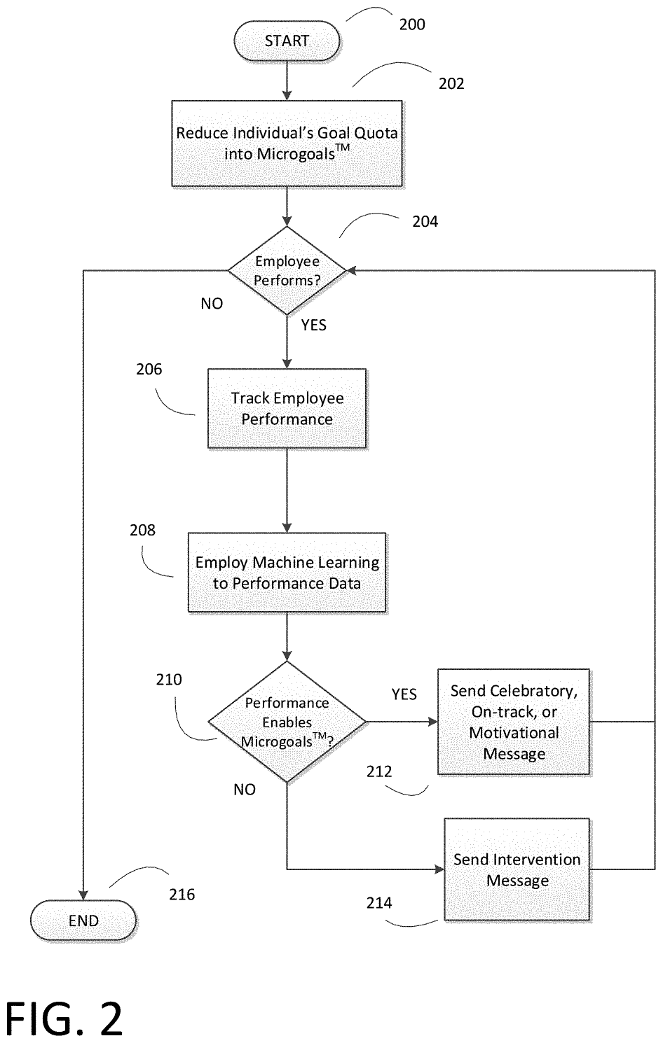

Turning now to FIG. 2, a process view of messaging determination consistent with certain embodiments of the present invention is shown. At 200, the process starts. At 202 the system reduces an individual employee's goal quota into the quota's smallest feasible trackable and measurable increments. Such increments are referred to herein as Microgoals™. At 204, the system determines whether the employee performs at all. If not, the process ends at 216. If so, at 206 the system tracks employee performance. The mechanics to affect such performance tracking vary by the nature of the employee task. For instance, by way of non-limiting example, employee performance may be tracked by monitoring the employee's physical movement, computer keystrokes or mouse clicks, voluntary reporting, or managerial reporting. By way of further non-limiting example, the system may use mechanical or electrical sensors or human observation to track employee performance. At 208 the system uses machine learning to analyze collected performance data for an individual employee. At 210 the system determines whether the employee performance enables the optimal attainment of the employee's Microgoals™. If so, at 212 the system sends at least a celebratory, on-track, or otherwise motivational message to the employee via an employee user interface on a user device. In general, “celebratory” messages indicate an employee's achieving a milestone or exceeding expectations, “on-track” messages indicate an employee's maintaining expectations, and “motivational” messages share information to help an employee to reach an expectation or celebrate an achievement. The system may alternatively or in addition send other messages or alerts to the employee via the employee user interface. Such messages or alerts may include but are not be limited to “time-based Microgoals™”, intended to alert an employee of remaining performance required to achieve a Microgoal™; “campaign reminders”, intended to remind an employee about current sales or marketing campaigns; “training recommendations”, intended to reinforce or to improve skills; “product advocacy”, intended to promote new or existing products and services; “peer-to-peer messages”, intended to promote social sharing or challenges amongst individual users, teams, managers, locations and business units; “individual to functional grouping messages”, intended to drive individual or group performance; and “alerts” intended to inform employees of events that have the potential to impact their performance such as, by way of non-limiting example, natural disasters, weather, political, local events, global events, terrorist events, and financial markets. If at 210 the system determines that an employee's performance does not further the employee's Microgoals™, then at 214 the system sends to the employee user interface an intervention message. Intervention messages may include, by way of non-limiting example, messages regarding the following: 1:1 coaching; Side-by-side coaching; Awards; Incentives; Peer-to-peer training; Assignment of training courses; Huddles; Best Practice Sharing; and Employee Interaction. In cases where the intervention message involves subsequent intervention for optimal results, the intervention message would result in summary peer or leadership interaction with the individual employee. Upon sending an intervention message or a celebratory, on-track, or motivational message, the system again determines whether the employee is performing the employee's task. If not, the system ends at 216. If so, the Microgoal™ evaluation and feedback loop continues at 206.

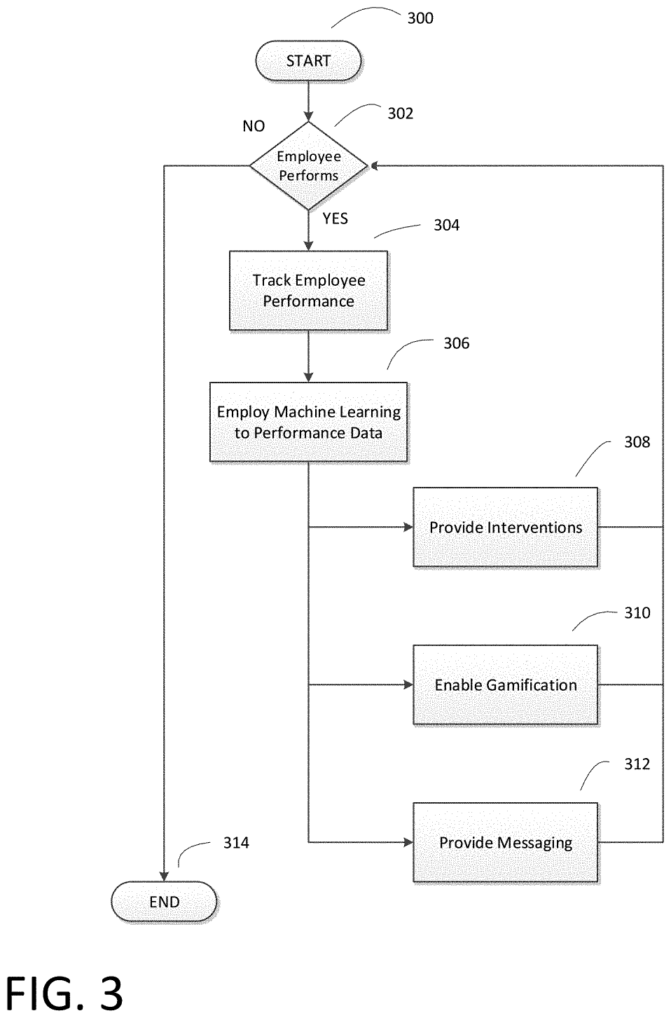

Turning now to FIG. 3, a process view of user intervention, gamification, and messaging determination consistent with certain embodiments of the present invention is shown. At 300 the process starts. At 302 the system determines if the employee is performing the employee's task. If not, the process ends at 314. If so, the system tracks employee performance at 304. Employee performance tracking results in employee-specific performance data regarding, by way of non-limiting example, productivity measured in number of tasks completed per unit of time, or number of specific results obtained per unit of effort. At 306 the system uses machine learning to analyze the employee's collected performance data. Based at least in part on such analysis, the system provides an employee with individualized interventions at 308, enables gamification at 310; or provides general messaging at 312. Enablement of gamification at 310 permits, in part, the employee's self-incentivizing to participate in task optimization. Examples of gamification can include, but are not limited to, Badges achieved; Points awarded; Levels of achievement (Silver, Gold, Platinum); Zones (1, 2, 3, 4, 5 or colors); Avatar skills, abilities or design; Virtual coins; Time off work; Certifications by level; and Individualized Rewards, in which individuals are allowed to choose their own reward and track progress toward its attainment. After provision of an intervention, enablement of gamification, or provision of messaging, the system at 302 again determines whether the employee performs. If not, the process ends at 314. If so, the employee feedback loop continues at 304.

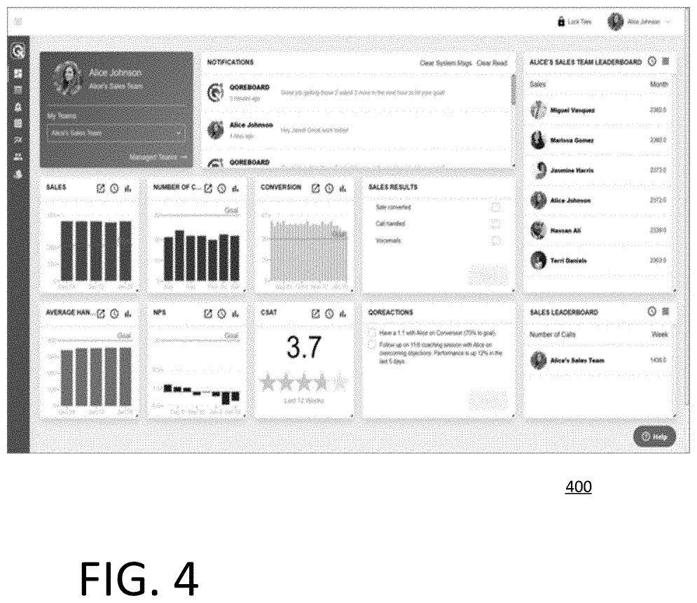

Turning now to FIG. 4, a view of a user experience of data visualization consistent with certain embodiments of the present invention is shown. User dashboard 400 reflects employee-specific data regarding an employee's adherence to Microgoal™ attainment. In an embodiment, such a dashboard informs an employee of the total number of Microgoals™, the number successfully completed, the employee's progress in relation to other employees, and the employee's contribution toward company macro goals.

While certain illustrative embodiments have been described, it is evident that many alternatives, modifications, permutations and variations will become apparent to those skilled in the art in light of the foregoing description.

I claim:

1. A system for providing a best way to present interventions to an employee, comprising:
a data server with a data processor;
a user device in communication with the data server;
parsing and anatomizing company goals and assigning results to employee groups;
parsing and anatomizing necessary contribution by an individual user and assigning results to the individual user;
collecting data on individual performance;
initiating a machine learning algorithm and said machine learning algorithm analyzing said collected data; and
presenting behavioral interventions resulting from said machine learning algorithm analysis to a user on said user device.

2. The system of claim 1 where the user device is a laptop computer, smart phone, desktop computer, tablet, or watch.

3. The system of claim 1 where the collected data is compared to an historical baseline.

4. The system of claim 1 where the behavioral interventions are presented as visualizations.

5. The system of claim 1 where the behavioral interventions include personalization.

6. The system of claim 5 where the personalization is determined in part through gamification.

7. A method for providing a best way to present interventions to an employee, comprising:
parsing and anatomizing company goals and assigning results to employee groups;
parsing and anatomizing necessary contribution by an individual user and assigning results to the individual user;
collecting data on individual performance using a user device in communication with a data server with a data processor;
analyzing said collected data through action of a machine learning algorithm; and
presenting behavioral interventions resulting from said machine learning algorithm analysis to a user on said user device.

8. The system of claim 7 where the user device is a laptop computer, smart phone, desktop computer, tablet or watch.

9. The system of claim 7 where the collected data is compared to an historical baseline.

10. The system of claim 7 where the behavioral interventions are presented as visualizations.

11. The system of claim 7 where the behavioral interventions include personalization.

12. The system of claim 11 where the personalization is determined in part through gamification.
